(19) United States
(12) Patent Application Publication
(10) Pub. No.: US 2017/0077473 A1
(43) Pub. Date: Mar. 16, 2017

(54) POLYOLEFIN COMPOSITE SEPARATOR, METHOD FOR MAKING THE SAME, AND LITHIUM ION BATTERY USING THE SAME

(71) Applicants: JIANGSU HUADONG INSTITUTE OF LI-ION BATTERY CO., LTD., Suzhou (CN); TSINGHUA UNIVERSITY, Beijing (CN)

(72) Inventors: Peng Zhao, Beijing (CN); Xiang-Ming He, Beijing (CN); Yu-Ming Shang, Beijing (CN); Li Wang, Beijing (CN); Ju-Ping Yang, Beijing (CN); Jian-Jun Li, Beijing (CN); Jian Gao, Beijing (CN); Yao-Wu Wang, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/359,377

(22) Filed: Nov. 22, 2016

Related U.S. Application Data
(63) Continuation of application No. PCT/CN2014/088915, filed on Oct. 20, 2014.

(30) Foreign Application Priority Data
May 22, 2014 (CN) 201410219157.3

(51) Int. Cl. H01M 2/14; C08J 7/16; H01M 10/0565; H01M 2/16; H01M 10/0525; C08J 9/36; C09D 4/00

(52) U.S. Cl. CPC H01M 2/145; C08J 9/365; C08J 7/16; C09D 4/00; H01M 2/1686; H01M 2/1653; H01M 10/0525; H01M 10/0565; C08J 2323/02; H01M 2300/0082

(57) ABSTRACT

A method for making a polyolefin composite separator is disclosed. Methyl methacrylate and γ-(triethoxysilyl)propyl methacrylate are polymerized to form a copolymer. The copolymer is dissolved in a first solvent to form a copolymer solution. The copolymer solution is applied to a surface of a polyolefin porous film, and dried to form a gel polymer electrolyte precursor layer on the surface of the polyolefin porous film. The polyolefin porous film having the gel polymer electrolyte precursor layer applied thereon is fumigated in an atmosphere of hydrochloric acid gas. A polyolefin composite separator and a lithium ion battery are also disclosed.

### CROSS-REFERENCE TO RELATED APPLICATIONS

This application claims all benefits accruing under 35 U.S.C. §119 from Chinese Patent Application No. 201410219157.3, filed on May 22, 2014 in the China Intellectual Property Office, the content of which is hereby incorporated by reference. This application is a continuation under 35 U.S.C. §120 of international patent application PCT/CN2014/088915 filed Oct. 20, 2014.

### FIELD

The present invention relates to polyolefin composite separators and methods for making the same, and lithium ion batteries using the same.

### BACKGROUND

With rapid developments of applications for lithium ion batteries in mobile phones, electric vehicles, and new energy fields such as energy storage systems, safety issues of the lithium ion batteries are getting particularly important. Based upon analysis for the causes, the safety of lithium ion batteries can be improved from the following aspects. The first is through optimizing the design and management of the lithium ion batteries, and monitoring charging and discharging processes in real-time to ensure safe use of lithium ion batteries. The second is to improve or develop new electrode materials to improve an intrinsic safety performance of the batteries. The third is to use safer electrolyte and separator to improve the safety performance of the batteries.

The separator is one of key components in an inner structure of the lithium ion battery. The separator allows electrolyte ions transferring therethrough, and separates a cathode from an anode to prevent short-circuit. Traditional lithium ion battery separators are made of polyolefins, such as polypropylene (PP) and polyethylene (PE). Via a porous forming process using a physical method (such as a stretching method) or a chemical method (such as an extraction method), a polyolefins porous film as the separator can be formed. As a matrix polymer of the separator, the polyolefin has a high strength and a good endurance in acid, alkali, and solvent. The drawback of the polyolefin is a lower melting point (polyethylene has a melting point of about 130° C., and polypropylene is about 160° C.), and a contraction along a hot stretching direction at a high temperature. In a battery thermal runaway, the temperature reaches near a melting point of the polymer, the separator shrinks dramatically causing a short-circuit between the cathode and anode. The short-circuit exacerbates the battery thermal runaway, and eventually leads to fire, explosion, and other accidents. In addition, the polyolefin separator has a low liquid absorption rate and a poor wettability to electrolyte solution, which are not conducive to improve the performance of the lithium ion batteries.

### BRIEF DESCRIPTION OF THE DRAWINGS

Implementations are described by way of example only with reference to the attached figures.

FIG. 1 is a flow chart of one embodiment of a method for making a polyolefin composite separator.

FIG. 2 is a schematic view of one embodiment of the polyolefin composite separator.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

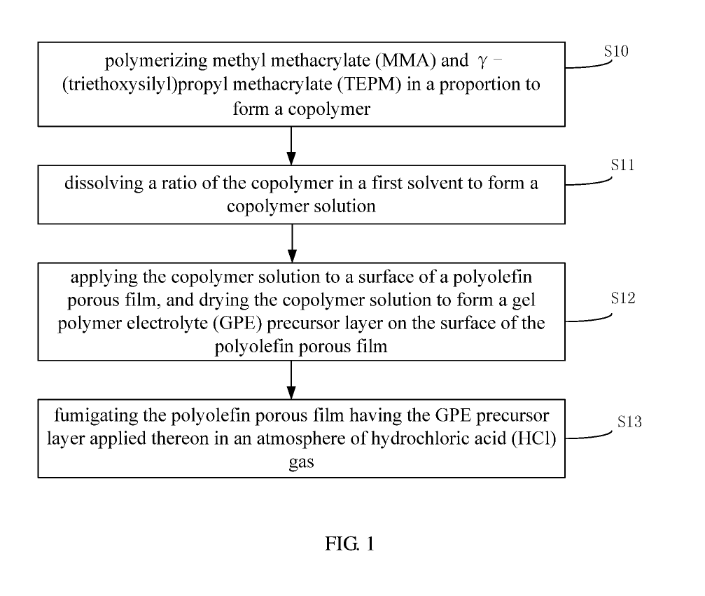

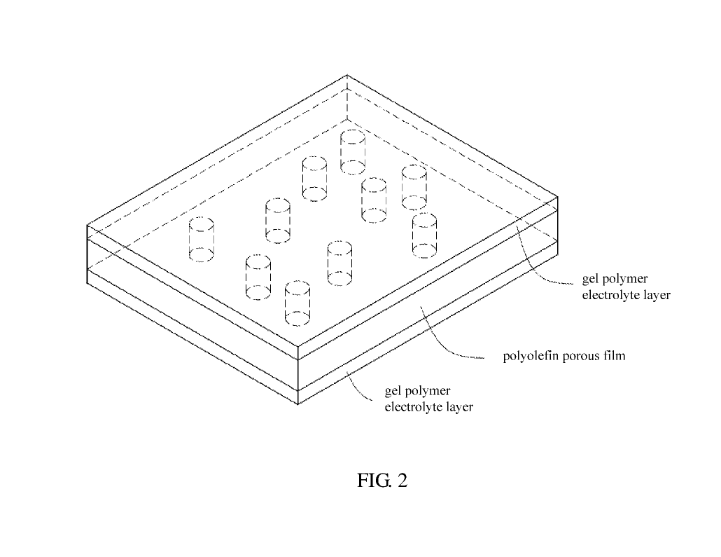

Referring to FIG. 1, one embodiment of a method for making a polyolefin composite separator, as shown in FIG. 2, comprises steps of:

S10, polymerizing methyl methacrylate (MMA) and γ-(triethoxysilyl)propyl methacrylate (TEPM) in a proportion to form a copolymer represented by a formula:

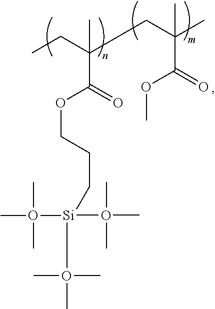

wherein m and n are integers;

S11, dissolving a ratio of the copolymer in a first solvent to form a copolymer solution;

S12, applying the copolymer solution to a surface of a polyolefin porous film, and drying the copolymer solution to form a gel polymer electrolyte (GPE) precursor layer on the surface of the polyolefin porous film; and

S13, fumigating the polyolefin porous film having the GPE precursor layer applied thereon in an atmosphere of hydrochloric acid (HCl) gas.

Step S10 comprises substeps of:

S101, mixing the MMA and TEPM in the proportion to form a mixture;

S102, adding an initiator to the mixture, stirring and heating the mixture to a reaction temperature to polymerize the MMA and TEPM to form a copolymer preform; and

S103, purifying the copolymer preform.

In step S101, the MMA and the TEPM having a molar ratio of m:n are miscible to each other in the mixture.

In step S102, the MMA and the TEPM undergo a radical polymerization to form the copolymer preform. The initiator can be an azo initiator, such as azobisisobutyronitrile (AIBN) and the like. The reaction temperature can be 70° C. to 90° C.

In step S103, the step of purifying the copolymer preform comprises:

S1031, dissolving the copolymer preform in a second solvent to form a copolymer preform solution; and

S1032, providing a mixed solvent of ethanol and water, and adding the copolymer preform solution to the mixed solvent to precipitating the copolymer.

In step S1031, the second solvent is not limited as long as it can dissolve the copolymer preform. The second solvent can be selected from organic solvents having a relatively large polarity and a boiling point lower than 100° C., such as tetrahydrofuran and the like.

In step S1032, because the copolymer cannot be dissolved in the mixed solvent, the copolymer can be precipitated from the mixed solvent, thereby forming the copolymer precipitate. The unreacted MMA and TEPM monomers are dissolved in the mixed solvent and to be removed, so as to achieve the purpose of separation and purification of the copolymer. A ratio of ethanol to water in the mixed solvent is not limited and can be formulated according to the m/n value. In one embodiment, m/n=1, and the ratio of ethanol to water is 1:2 to 2:1.

It can be understood that step S103 can be repeated to obtain a high purity polymer. Experiments show that the MMA and the TEPM remaining in the copolymer preform can be completely removed by repeating step S103, such as at least three times.

In step S11, a concentration of the copolymer in the copolymer solution can be in a range from about 5% to about 15%. The first solvent is not limited and can be the same as the second solvent, that is, an organic solvent having a relatively large polarity and a boiling point lower than 100° C.

In step S12, a thickness of the GPE precursor layer can be about 5 microns (μm). The thickness of the GPE precursor layer can be controlled by controlling the thickness of the copolymer solution that is applied by a knife coating on the surface of the polyolefin porous film. The polyolefin porous film can be a polypropylene porous film, a polyethylene porous film, or a film structure in which a polypropylene porous film and a polyethylene porous film are laminated. The polyolefin porous film can be a lithium ion battery separator for blocking electrons and allowing lithium ions transferring therethrough. The polyolefin porous film can be commercially available as a separator. In one embodiment, the polyolefin porous film is a celgard-2325 separator.

In step S13, during the fumigating, siloxane groups in the GPE precursor layer can be crosslinked to form silicon oxide crosslinking system, resulting in a GPE layer on the surface of the polyolefin porous film, thereby forming the polyolefin composite separator. The polyolefin porous film having the GPE precursor layer applied thereon can be fumigated in the atmosphere of hydrochloric acid for a period of time that is not limited and can be about 24 hours to about 36 hours.

After the step S13, the hydrochloric acid remaining on the polyolefin composite separator can be removed, such as ultrasonically cleaned with a volatile organic solvent, and the polyolefin composite separator can be dried. The volatile organic solvent can be selected from ethanol, acetone, and the like.

In use, the polyolefin composite separator can be immersed in an electrolyte liquid.

One embodiment of a polyolefin composite separator comprises a polyolefin porous film and a copolymer film disposed on a surface of the polyolefin porous film. The copolymer film comprises polymethyl methacrylate-poly-γ-(triethoxysilyl)propyl methacrylate having a silicon oxide crosslinking system formed from crosslinked siloxane groups.

One embodiment of a lithium ion battery comprises a cathode electrode, an anode electrode, and a gel polymer electrolyte separator disposed between the cathode electrode and the anode electrode. The gel polymer electrolyte separator comprises the polyolefin composite separator and a nonaqueous electrolyte solution infiltrated in the polyolefin composite separator.

The nonaqueous electrolyte solution comprises a solvent and a lithium salt dissolved in the solvent. The solvent can be selected from the group consisting of cyclic carbonates, chain carbonates, cyclic ethers, chain ethers, nitriles, and amides, such as ethylene carbonate, propylene carbonate, diethyl carbonate, dimethyl carbonate, ethylmethyl carbonate, methyl acetate, ethyl acetate, propyl acetate, methyl propionate, ethyl propionate, diethyl ether, acetonitrile, propionitrile, anisole, butyrate, glutaronitrile, hexanedinitrile, γ-butyrolactone, γ-valerolactone, tetrahydrofuran, 1,2-dimethoxyethane, dimethylformamide, and combinations thereof. The lithium salt can be selected from the group consisting of lithium chloride (LiCl), lithium hexafluorophosphate (LiPF₆), lithium tetrafluoroborate (LiBF₄), lithium methanesulfonate (LiCH₃SO₃), lithium trifluoromethanesulfonate (LiCF₃SO₃), lithium hexafluoroarsenate (LiAsF₆), lithium perchlorate (LiClO₄), lithium bis (oxalate) borate (LiBOB), and combinations thereof.

The cathode electrode can comprise a cathode current collector and a cathode material layer. The cathode current collector supports the cathode material layer and conducts current. The cathode current collector can have a foil shape or a net shape. The material of the cathode current collector can be selected from aluminum, titanium, or stainless steel. The cathode material layer can be disposed on at least one surface of the cathode current collector. The cathode material layer comprises a cathode active material, and can further optionally comprise a conductive agent and a binder. The conductive agent and the binder can be uniformly mixed with the cathode active material. The cathode active material can be, for example, selected from olivine type lithium iron phosphate, spinel type lithium manganese oxide, layered type lithium cobalt oxide, layered type lithium nickel oxide, and combinations thereof.

The anode electrode can comprise an anode current collector and an anode material layer. The anode current collector supports the anode material layer and conducts current. The anode current collector can have a foil shape or a net shape. The material of the anode current collector can be selected from copper, nickel, or stainless steel. The anode material layer can be provided on at least one surface of the anode current collector. The anode material layer comprises an anode active material, and can further optionally comprise a conductive agent and a binder. The conductive agent and the binder can be uniformly mixed with the anode active material. The anode active material can be selected from graphite, acetylene black, microbead carbon, carbon fiber, carbon nanotube, pyrolytic carbon, and combinations thereof.

The polyolefin composite separator provided by the embodiments of the present disclosure improves the liquid absorption and the gas permeability of the composite separator by the PMMA, and improves the thermal shrinking resistance of the composite separator by the poly-γ-(triethoxysilyl)propyl methacrylate. The polyolefin composite separator has a good safety performance, improves the current rating performance of the lithium ion battery using the polyolefin composite separator. In addition, the method for preparing the polyolefin composite separator is simple for industrialization.

### Example 1

The MMA and TEPM having a molar ratio of 1:1 are uniformly mixed together, added with an amount of AIBN to form a mixture. The mixture is stirred and polymerized at 80° C. to form the copolymer preform. The copolymer preform is dissolved in tetrahydrofuran to form the copolymer preform solution. The copolymer preform solution is added to the mixed solvent of ethanol and water (volume ratio 1:1) to form a precipitate. The addition of the copolymer preform solution to the mixed solvent and the precipitation from the mixed solvent is repeated a number of times, such as three times, to obtain the copolymer, which is the polymethyl methacrylate-poly-γ-(triethoxysilyl)propyl methacrylate. The copolymer is dissolved in tetrahydrofuran to form the copolymer solution. The copolymer solution is knife coated to two surfaces of a microporous membrane, such as Celgard® 2325 film, and dried. The membrane, such as the Celgard® 2325 film, coated with the copolymer is then fumigated in concentrated hydrochloric acid gas atmosphere for about 48 hours. The obtained film from the fumigation is ultrasonically cleaned with ethanol and dried in vacuum to form the composite separator having a thickness of about 40 microns.

### Comparative Example 1

An untreated Celgard® 2325 film is used as a separator.

### Comparative Example 2

The only difference between Comparative Example 2 and Example 1 is that TEPM is removed from the mixture in Comparative Example 2. That is, only the MMA is polymerized.

### Comparative Example 3

The only difference between Comparative Example 2 and Example 1 is that MMA is removed from the mixture in Comparative Example 2. That is, only the TEPM is polymerized.

Parameters such as gas permeability, contact angle, liquid absorption rate, electrical conductivity, and heat shrinkage performance of the separator obtained in the above Example 1 and Comparative Examples 1 to 3 are measured, and the parameters obtained by the tests are shown in Table 1.

TABLE 1

| | Comparative | Comparative | Comparative | |
|---|---|---|---|---|
| | Example 1 | Example 2 | Example 3 | Example 1 |
| Gurley Number | 1035 | 3164 | 2097 | 2500 |
| (s/[in² * 100 cc * | | | | |
| 1.22 kPa]) | | | | |
| Contact Angle | 46 | 12.8 | 20 | 16.8 |
| Liquid absorption | 80 | 136 | 85 | 96 |
| rate (%) | | | | |
| Electrical | 4.98 | 2.93 | 1.99 | 2.61 |
| Conductivity | | | | |
| (*10⁻⁴ S/cm) | | | | |
| Thermal | 39.4 | 30.5 | 8 | 9.8 |
| Shrinkage | | | | |
| Rate (%) | | | | |

As can be seen from Table 1, PMMA can significantly improve the liquid absorption rate and gas permeability of the composite separator, resulting in an increase in the current rate performance of the lithium ion battery, but has little effect on thermal shrinkage performance. The silicon oxide crosslinking system formed by polymerized TEPM can significantly improve the thermal shrinkage resistance of the composite separator, but has little effect on the liquid absorption rate and gas permeability. By addition of both polymethyl methacrylate and poly-γ-(triethoxysilyl)propyl methacrylate, the safety performance and the current rating of the lithium ion battery using the polyolefin composite separator of the present disclosure can be improved.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for making a polyolefin composite separator comprising:
polymerizing methyl methacrylate and γ-(triethoxysilyl)propyl methacrylate to form a copolymer, the copolymer is represented by a formula: 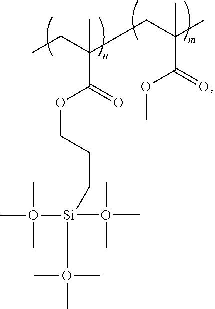
wherein m and n are integers;
dissolving the copolymer in a first solvent to form a copolymer solution;
applying the copolymer solution to a surface of a polyolefin porous film;
drying the copolymer solution to form a gel polymer electrolyte precursor layer on the surface of the polyolefin porous film; and
fumigating the polyolefin porous film having the gel polymer electrolyte precursor layer applied thereon in an atmosphere of hydrochloric acid gas.

2. The method of claim 1, wherein the polymerizing comprises:
mixing the methyl methacrylate and the γ-(triethoxysilyl)propyl methacrylate to form a mixture;
adding an initiator to the mixture, stirring and heating the mixture having the initiator to a reaction temperature to polymerize the methyl methacrylate and the γ-(triethoxysilyl)propyl methacrylate to form a copolymer preform; and
purifying the copolymer preform.

3. The method of claim 2, wherein a molar ratio of the methyl methacrylate to the γ-(triethoxysilyl)propyl methacrylate is m:n.

4. The method of claim 3, wherein m:n=1.

5. The method of claim 2, wherein the reaction temperature is in a range from about 70° C. to about 90° C.

6. The method of claim 2, wherein the initiator is an azo initiator.

7. The method of claim 2, wherein the purifying comprises:
dissolving the copolymer preform in a second solvent to form a copolymer preform solution; and
providing a mixed solvent of ethanol and water, and adding the copolymer preform solution to the mixed solvent to precipitate the copolymer.

8. The method of claim 7, wherein, a volume ratio of the ethanol to the water is in a range from 1:2 to 2:1.

9. The method of claim 1, wherein a concentration of the copolymer in the copolymer solution is in a range from about 5% to about 15%.

10. The method of claim 1, wherein the fumigating lasts for about 24 hours to about 36 hours.

11. The method of claim 1, wherein the fumigating comprises crosslinking siloxane groups in the gel polymer electrolyte precursor layer to form a silicon oxide crosslinking system.

12. The method of claim 1, further comprising removing hydrochloric acid from the polyolefin porous film after the fumigating.

13. The method of claim 12, wherein the removing comprises ultrasonically vibrating the polyolefin porous film in a volatile organic solvent, and drying the polyolefin porous film.

14. A polyolefin composite separator comprising a polyolefin porous film and a copolymer film disposed on a surface of the polyolefin porous film, the copolymer film comprises polymethyl methacrylate-poly-γ-(triethoxysilyl)propyl methacrylate having a silicon oxide crosslinking system formed from crosslinked siloxane groups.

15. A lithium ion battery comprising a cathode electrode, an anode electrode, and a gel polymer electrolyte separator disposed between the cathode electrode and the anode electrode, wherein the gel polymer electrolyte separator comprises a polyolefin composite separator and a nonaqueous electrolyte solution infiltrated in the polyolefin composite separator, the polyolefin composite separator comprises a polyolefin porous film and a copolymer film disposed on a surface of the polyolefin porous film, and the copolymer film comprises polymethyl methacrylate-poly-γ-(triethoxysilyl)propyl methacrylate having a silicon oxide crosslinking system formed from crosslinked siloxane groups.
